(19) United States
(12) Patent Application Publication
(10) Pub. No.: US 2024/0005085 A1
(43) Pub. Date: Jan. 4, 2024

(54) METHODS AND SYSTEMS FOR GENERATING SUMMARIES

(71) Applicant: RingCentral, Inc., Belmont, CA (US)

(72) Inventors: Prashant Kukde, Miliptas, CA (US); Sushant Hiray, Redwood City, CA (US)

(21) Appl. No.: 17/853,311

(22) Filed: Jun. 29, 2022

(51) Int. Cl. G06F 40/166; G06F 40/284; G06F 40/30; G10L 15/22; G10L 15/18; G10L 25/78; G10L 25/51

(52) U.S. Cl. CPC G06F 40/166; G06F 40/284; G06F 40/30; H04L 65/403; G10L 15/1815; G10L 25/78; G10L 25/51; G10L 15/22

(57) ABSTRACT

A computer-implemented machine learning method for generating real-time summaries is provided. The method comprises identifying a speech segment during a conference session, generating a real-time transcript from the speech segment, determining a topic from the real-time transcript, generating a summary of the topic, and streaming the summary of the topic during the conference session.

### TECHNICAL FIELD

The present disclosure relates generally to the field of virtual meetings. Specifically, the present disclosure relates to systems and methods for generating abstractive summaries during video, audio, virtual reality (VR), and/or augmented reality (AR) conferences.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Virtual conferencing has become a standard method of communication for both professional and personal meetings. However, any number of factors may cause interruptions to a virtual meeting that result in participants missing meeting content. For example, participants sometimes join a virtual conferencing session late, disconnect and reconnect due to network connectivity issues, or are interrupted for personal reasons. In these instances, the host or another participant is often forced to recapitulate the content that was missed, resulting in wasted time and resources. Moreover, existing methods of automatic speech recognition (ASR) generate verbatim transcripts that are exceedingly verbose, resource-intensive to generate and store, and ill-equipped for providing succinct summaries. Therefore, there is a need for improving upon existing techniques by intelligently summarizing live content.

### SUMMARY

The appended claims may serve as a summary of the invention.

### BRIEF DESCRIPTION OF THE DRAWINGS

FIG. 1 is a network diagram depicting a networked collaboration system, in an example embodiment.

FIG. 2 is a diagram of a server system, in an example embodiment.

FIG. 3 is a relational node diagram depicting a neural network, in an example embodiment.

FIG. 4 is a block diagram of a live summarization process, in an example embodiment.

FIG. 5 is a flowchart depicting a summary process, in an example embodiment.

FIG. 6 is a diagram of a conference server, in an example embodiment.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IoT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood that terms “user” and “participant” have equal meaning in the following description.

Embodiments are described in sections according to the following outline:
1.0 GENERAL OVERVIEW
2.0 STRUCTURAL OVERVIEW
3.0 FUNCTIONAL OVERVIEW
   3.1 Machine Learning
   3.2 Voice Activity Module
   3.3 ASR Module
   3.4 Speaker-Aware Context Module
   3.5 Topic Context Module
   3.6 Summarization Module
   3.7 Post-Processing Module
   3.8 Display Module
4.0 PROCEDURAL OVERVIEW

### 1.0 General Overview

Traditional methods of ASR generate transcripts that are exceedingly verbose, resource-intensive to generate and store, and ill-equipped for providing succinct summaries. There are known techniques of extractive summaries where full-length transcripts are highlighted as a method of summarization. However, mere extractions create problems when trying to identify the owner of pronouns such as “he” or “she” when taken out-of-context. Therefore, there is a need for intelligent and live streaming of abstractive summaries that repackage the content of the conferencing session succinctly using different words such that the content retains its meaning, even out of context.

Moreover, abstractive summarization of multi-party conversations involves solving for a different type of technical problem than summarizing news articles, for example. While news articles provide texts that are already organized, conversations often switch from speaker to speaker, veer off-topic, and include less relevant or irrelevant side conversations. This lack of a cohesive sequence of logical topics makes accurate summarizations of on-going conversations difficult. Therefore, there is also a need to create summaries that ignore irrelevant side conversations and take into account emotional cues or interruptions to identify important sections of any given topic of discussion.

The current disclosure provides an artificial intelligence (AI)-based technological solution to the technological problem of basic word-for-word transcriptions and inaccurate abstractive summarization. Specifically, the technological solution involves using a series of machine learning (ML) algorithms or models to accurately identify speech segments, generate a real-time transcript, subdivide these live, multi-turn speaker-aware transcripts into topic context units representing topics, generate abstractive summaries, and stream those summaries to conference participants. Consequently, this solution provides the technological benefit of improving conferencing systems by providing live summarizations of on-going conferencing sessions. Since the conferencing system improved by this method is capable of generating succinct, meaningful, and more accurate summaries from otherwise verbose transcripts of organic conversations that are difficult to organize, the current solutions also provide for generating and displaying information that users otherwise would not have had.

A computer-implemented machine learning method for generating real-time summaries is provided. The method comprises identifying a speech segment during a conference session; generating a real-time transcript from the speech segment identified during the conference session; determining a topic from the real-time transcript generated from the speech segment; generating a summary of the topic; and streaming the summary of the topic during the conference session.

A non-transitory, computer-readable medium storing a set of instructions is also provided. In an example embodiment, when the instructions are executed by a processor, the instructions cause identifying a speech segment during a conference session; generating a real-time transcript from the speech segment identified during the conference session; determining a topic from the real-time transcript generated from the speech segment; generating a summary of the topic; and streaming the summary of the topic during the conference session.

A machine learning system for generating real-time summaries is also provided. The system includes a processor and a memory storing instructions that, when executed by the processor, cause identifying a speech segment during a conference session; generating a real-time transcript from the speech segment identified during the conference session; determining a topic from the real-time transcript generated from the speech segment; generating a summary of the topic; and streaming the summary of the topic during the conference session.

### 2.0 Structural Overview

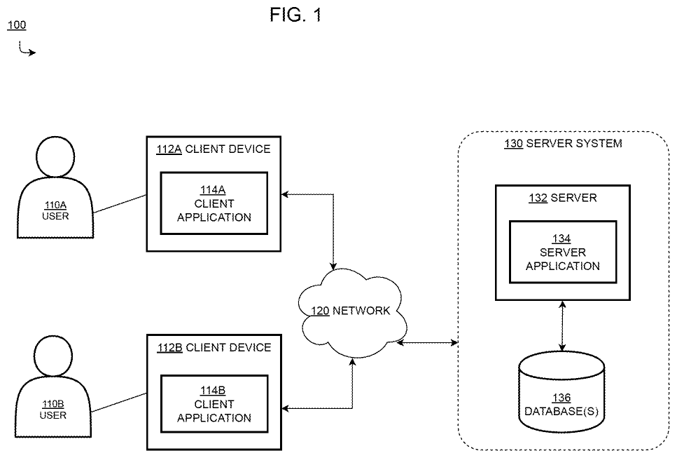

FIG. 1 shows an example collaboration system 100 in which various implementations as described herein may be practiced. The collaboration system 100 enables a plurality of users to collaborate and communicate through various means, including audio and/or video conference sessions, VR, AR, email, instant message, SMS and MMS message, transcriptions, closed captioning, or any other means of communication. In some examples, one or more components of the collaboration system 100, such as client device(s) 112A, 112B and server 132, can be used to implement computer programs, applications, methods, processes, or other software to perform the described techniques and to realize the structures described herein. In an embodiment, the collaboration system 100 comprises components that are implemented at least partially by hardware at one or more computing devices, such as one or more hardware processors executing program instructions stored in one or more memories for performing the functions that are described herein.

As shown in FIG. 1, the collaboration system 100 includes one or more client device(s) 112A, 112B that are accessible by users 110A, 110B, a network 120, a server system 130, a server 132, and a database 136. The client devices 112A, 112B are configured to execute one or more client application(s) 114A, 114B, that are configured to enable communication between the client devices 112A, 112B and the server 132. In some embodiments, the client applications 114A, 114B are web-based applications that enable connectivity through a browser, such as through Web Real-Time Communications (WebRTC). The server 132 is configured to execute a server application 134, such as a server back-end that facilitates communication and collaboration between the server 132 and the client devices 112A, 121B. In some embodiments, the server 132 is a WebRTC server. The server 132 may use a Web Socket protocol, in some embodiments. The components and arrangements shown in FIG. 1 are not intended to limit the disclosed embodiments, as the system components used to implement the disclosed processes and features can vary.

As shown in FIG. 1, users 110A, 110B may communicate with the server 132 and each other using various types of client devices 112A, 112B via network 120. As an example, client devices 112A, 112B may include a display such as a television, tablet, computer monitor, video conferencing console, or laptop computer screen. Client devices 112A, 112B may also include video/audio input devices such as a microphone, video camera, web camera, or the like. As another example, client device 112A, 112B may include mobile devices such as a tablet or a smartphone having display and video/audio capture capabilities. In some embodiments, the client device 112A, 112B may include AR and/or VR devices such as headsets, glasses, etc. Client devices 112A, 112B may also include one or more software-based client applications that facilitate the user devices to engage in communications, such as instant messaging, text messages, email, Voice over Internet Protocol (VoIP) calls, video conferences, and so forth with one another. In some embodiments, the client application 114A, 114B may be a web browser configured to enabled browser-based WebRTC conferencing sessions. In some embodiments, the systems and methods further described herein are implemented to separate speakers for WebRTC conferencing sessions and provide the separated speaker information to a client device 112A, 112B.

The network 120 facilitates the exchanges of communication and collaboration data between client device(s) 112A, 112B and the server 132. The network 120 may be any type of networks that provides communications, exchanges information, and/or facilitates the exchange of information between the server 132 and client device(s) 112A, 112B. For example, network 120 broadly represents a one or more local area networks (LANs), wide area networks (WANs), metropolitan area networks (MANs), global interconnected internetworks, such as the public internet, public switched telephone networks (“PSTN”), or other suitable connection(s) or combination thereof that enables collaboration system 100 to send and receive information between the components of the collaboration system 100. Each such network 120 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 120 and the disclosure presumes that all elements of FIG. 1 are communicatively coupled via network 120. A network may support a variety of electronic messaging formats and may further support a variety of services and applications for client device(s) 112A, 112B.

The server system 130 can be a computer-based system including computer system components, desktop computers, workstations, tablets, hand-held computing devices, memory devices, and/or internal network(s) connecting the components. The server 132 is configured to provide communication and collaboration services, such as telephony, audio and/or video conferencing, VR or AR collaboration, webinar meetings, messaging, email, project management, or any other types of communication between users. The server 132 is also configured to receive information from client device(s) 112A, 112B over the network 120, process the unstructured information to generate structured information, store the information in a database 136, and/or transmit the information to the client devices 112A, 112B over the network 120. For example, the server 132 may be configured to receive physical inputs, video signals, audio signals, text data, user data, or any other data, analyze the received information, separate out the speakers associated with client devices 112A, 112B and generate real-time summaries. In some embodiments, the server 132 is configured to generate a transcript, closed-captioning, speaker identification, and/or any other content in relation to real-time, speaker-specific summaries.

In some implementations, the functionality of the server 132 described in the present disclosure is distributed among one or more of the client devices 112A, 112B. For example, one or more of the client devices 112A, 112B may perform functions such as processing audio data for speaker separation and generating abstractive summaries. In some embodiments, the client devices 112A, 112B may share certain tasks with the server 132.

Database(s) 136 may include one or more physical or virtual, structured or unstructured storages coupled with the server 132. The database 136 may be configured to store a variety of data. For example, the database 136 may store communications data, such as audio, video, text, or any other form of communication data. The database 136 may also store security data, such as access lists, permissions, and so forth. The database 136 may also store internal user data, such as names, positions, organizational charts, etc., as well as external user data, such as data from as Customer Relation Management (CRM) software, Enterprise Resource Planning (ERP) software, project management software, source code management software, or any other external or third-party sources. In some embodiments, the database 136 may also be configured to store processed audio data, ML training data, or any other data. In some embodiments, the database 136 may be stored in a cloud-based server (not shown) that is accessible by the server 132 and/or the client devices 112A, 112B through the network 120. While the database 136 is illustrated as an external device connected to the server 132, the database 136 may also reside within the server 132 as an internal component of the server 132.

### 3.0 Functional Overview

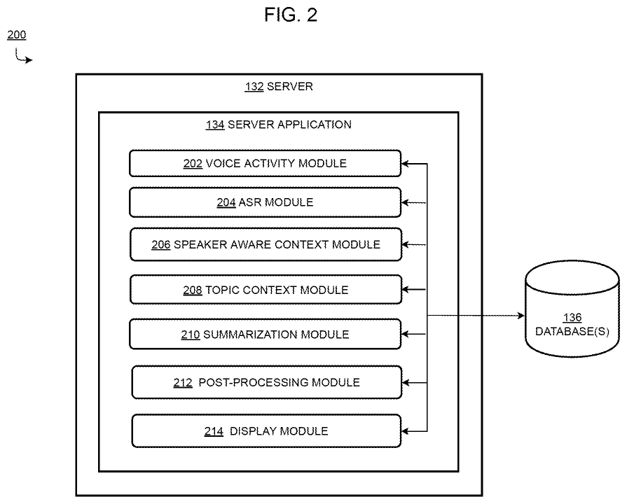

FIG. 2 is a diagram of a server system 200, such as server system 130 in FIG. 1, in an example embodiment. A server application 134 may contain sets of instructions or modules which, when executed by one or more processors, perform various functions related to generating intelligent live summaries. In the example of FIG. 2, the server system 200 may be configured with a voice activity module 202, an ASR module 204, a speaker-aware context module 206, a topic context module 208, a summarization module 210, a post-processing module 212, and a display module 214, as further described herein. While seven modules are depicted in FIG. 2, the embodiment of FIG. 2 serves as an example and is not intended to be limiting. For example, fewer modules or more modules serving any number of purposes may be used.

### 3.1 Machine Learning

One or more of the modules discussed herein may use ML algorithms or models. In some embodiments, all the modules of FIG. 2 comprise one or more ML models or implement ML techniques. For instance, any of the modules of FIG. 2 may be one or more of: Voice Activity Detection (VAD) models, Gaussian Mixture Models (GMM), Deep Neural Networks (DNN), Recurrent Neural Network (RNN), Time Delay Neural Networks (TDNN), Long Short-Term Memory (LSTM) networks, Agglomerative Hierarchical Clustering (AHC), Divisive Hierarchical Clustering (DHC), Hidden Markov Models (HMM), Natural Language Processing (NLP), Convolution Neural Networks (CNN), General Language Understanding Evaluation (GLUE), Word2Vec, Gated Recurrent Unit (GRU) networks, Hierarchical Attention Networks (HAN), or any other type of machine learning model. The models listed herein serve as examples and are not intended to be limiting.

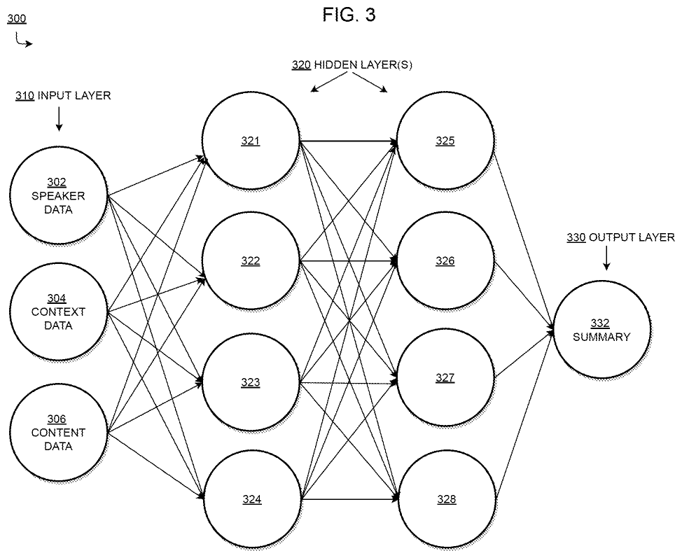

In an embodiment, each of the machine learning models are trained on one or more types of data in order to generate live summaries. Using the neural network 300 of FIG. 3 as an example, a neural network 300 may include an input layer 310, one or more hidden layers 320, and an output layer 330 to train the model to perform various functions in relation to generating abstractive summaries. In some embodiments, where the training data is labeled, supervised learning is used such that known input data, a weighted matrix, and known output data is used to gradually adjust the model to accurately compute the already known output. In other embodiments, where the training data is not labeled, unsupervised and/or semi-supervised learning is used such that a model attempts to reconstruct known input data over time in order to learn.

Training of example neural network 300 using one or more training input matrices, a weight matrix, and one or more known outputs may be initiated by one or more computers associated with the ML modules. For example, one, some, or all of the modules of FIG. 2 may be trained by one or more training computers, and once trained, used in association with the server 132 and/or client devices 112A, 112B, to process live audio, video, or any other types of data during a conference session for the purposes of intelligent summarization. In an embodiment, a computing device may run known input data through a deep neural network in an attempt to compute a particular known output. For example, a server, such as server 132, uses a first training input matrix and a default weight matrix to compute an output. If the output of the deep neural network does not match the corresponding known output of the first training input matrix, the server 132 may adjust the weight matrix, such as by using stochastic gradient descent, to slowly adjust the weight matrix over time. The server 132 may then re-compute another output from the deep neural network with the input training matrix and the adjusted weight matrix. This process may continue until the computer output matches the corresponding known output. The server 132 may then repeat this process for each training input dataset until a fully trained model is generated.

In the example of FIG. 3, the input layer 310 may include a plurality of training datasets that are stored as a plurality of training input matrices in an associated database, such as database 136 of FIG. 2. In some embodiments, the training datasets may be updated and the ML models retrained using the updated data. In some embodiments, the updated training data may include, for example, user feedback or other user input.

The training input data may include, for example, speaker data 302, context data 304, and/or content data 306. In some embodiments, the speaker data 302 is any data pertaining to a speaker, such as a name, username, identifier, gender, title, organization, avatar or profile picture, or any other data associated with the speaker. The context data 304 may be any data pertaining to the context of a conferencing session, such as timestamps corresponding to speech, the time and/or time zone of the conference session, emotions or speech patterns exhibited by the speakers, biometric data associated with the speakers, or any other data. The content data 306 may be any data pertaining to the content of the conference session, such as the exact words spoken, topics derived from the content discussed, or any other data pertaining to the content of the conference session. While the example of FIG. 3 specifies speaker data 302, context data 304, and/or content data 306, the types of data are not intended to be limiting. Moreover, while the example of FIG. 3 uses a single neural network, any number of neural networks may be used to train any number of ML models to separate speakers and generate abstractive summaries.

In the embodiment of FIG. 3, hidden layers 320 may represent various computational nodes 321, 322, 323, 324, 325, 326, 327, 328. The lines between each node 321, 322, 323, 324, 325, 326, 327, 328 may represent weighted relationships based on the weight matrix. As discussed above, the weight of each line may be adjusted overtime as the model is trained. While the embodiment of FIG. 3 features two hidden layers 320, the number of hidden layers is not intended to be limiting. For example, one hidden layer, three hidden layers, ten hidden layers, or any other number of hidden layers may be used for a standard or deep neural network. The example of FIG. 3 may also feature an output layer 330 with a summary 332 as the output. The summary 332 may be one or more abstractive summaries of the topics discussed during the conference session. As discussed above, in this structured model, the summary 332 may be used as a target output for continuously adjusting the weighted relationships of the model. When the model successfully outputs an accurate summary 332, then the model has been trained and may be used to process live or field data.

Once the neural network 300 of FIG. 3 is trained, the trained model may accept field data at the input layer 310, such as speaker data 302, context data 304, content data 306 or any other types of data from current conferencing sessions. In some embodiments, the field data is live data that is accumulated in real time, such as during a live audio-video conferencing session. In other embodiments, the field data may be current data that has been saved in an associated database, such as database 136 of FIG. 2. The trained model may be applied to the field data in order to generate a summary 332 at the output layer 330. For instance, a trained model can generate abstractive summaries and stream those summaries to one or more conference participants.

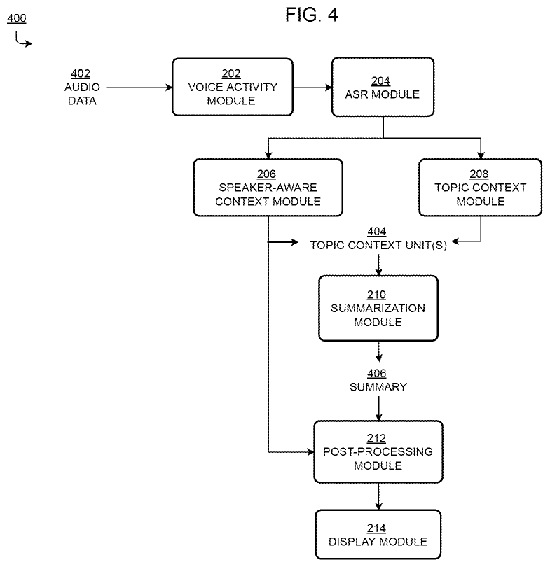

FIG. 4 is a block diagram of a live summarization process 400, in an example embodiment. The live summarization process 400 may be understood in relation to the voice activity module 202, ASR module 204, speaker-aware context module 206, topic context module 208, summarization module 210, post-processing module 212, and display module 214, as further described herein.

### 3.2 Voice Activity Module

In some embodiments, audio data 402 is fed into a voice activity module 202. In some embodiments, audio data 402 may include silence, sounds, non-spoken sounds, background noises, white noise, spoken sounds, speakers of different genders with different speech patterns, or any other types of audio from one or more sources. The voice activity module 202 may use ML methods to extract features from the audio data 402. The features may be Mel-Frequency Cepstral Coefficients (WIFCC) features, which are then passed as input into one or more VAD models, for example. In some embodiments, a GMM model is trained to detect speech, silence, and/or background noise from audio data. In other embodiments, a DNN model is trained to enhance speech segments of the audio, clean up the audio, and/or detect the presence or complete presence of a noise. In some embodiments, one or both GMM and DNN models are used, while in other embodiments, other known ML learning techniques are used based on latency requirements, for example. In some embodiments, all these models are used together to weigh every frame and tag these data frames as speech or non-speech. In some embodiments, separating speech segments from non-speech segments focuses the process 400 on summarizing sounds that have been identified as spoken words such that resources are not wasted processing non-speech segments.

In some embodiments, the voice activity module 202 processes video data and determines the presence or absence of spoken words based on lip, mouth, and/or facial movement. For example, the voice activity module 202, trained on video data to read lips, may determine the specific words or spoken content based on lip movement.

### 3.3 ASR Module

In some embodiments, the speech segments extracted by the voice activity module 202 are passed to an ASR module 204. In some embodiments, the ASR module 204 uses standard techniques for real-time transcription to generate a transcript. For example, the ASR module 204 may use a DNN with end-to-end Connectionist Temporal Classification (CTC) for automatic speech recognition. In some embodiments, the model is fused with a variety of language models. In some embodiments, a beam search is performed at run-time to choose an optimal ASR output for the given stream of audio. The outputted real-time transcript may be fed into the speaker-aware context module 206 and/or the topic context module 208, as further described herein.

In some embodiments where the voice activity module 202 processes video data, the ASR module 204 may be exchanged for an automated lip reading (ALR) or an audio visual-automatic speech recognition (AV-ASR) machine learning model that automatically determines spoken words based on video data or audio-video data.

### 3.4 Speaker-Aware Context Module

In some embodiments, a speaker-aware context module 206 annotates the text transcript created from the ASR module 204 with speaker information, timestamps, or any other data related to the speaker and/or conference session. For example, a speaker's identity and/or timestamp(s) may be tagged as metadata along with the audio stream for the purposes of creating transcription text that identify each speaker and/or a timestamp of when each speaker spoke. In some embodiments, the speaker-aware context module 306 obtains the relevant tagging data, such as a name, gender, or title, from a database 136 storing information related to the speaker, the organization that the speaker belongs to, the conference session, or from any other source. While the speaker-aware context module 206 is optional, in some embodiments, the speaker tagging is used subsequently to create speaker-specific abstractive summaries, as further described herein. In some embodiments, this also enables filtering summaries by speaker and for summaries that capture individual perspectives rather than a group-level perspective.

### 3.5 Topic Context Module

A topic context module 208 divides the text transcript from the ASR module 204 into topic context unit(s) 404 or paragraphs that represent separate topics, in some embodiments. In some embodiments, the topic context module 208 detects that a topic shift or drift has occurred and delineates a boundary where the drift occurs in order to generate these topic context units 404 representing topics.

The direction of a conversation may start diverging when a topic comes to a close, such as when a topic shifts from opening pleasantries to substantive discussions, or from substantive discussions to concluding thoughts and action items. To detect a topic shift or drift, sentence vectors may be generated for each sentence and compared for divergences, in some embodiments. By converting the text data into a numerical format, the similarities or differences between the texts may be computed. For example, word embedding techniques such as Bag of Words, Word2Vec, or any other embedding techniques may be used to encode the text data such that semantic similarity comparisons may be performed. Since the embeddings have a limit on content length (e.g. tokens), rolling averages may be used to compute effective embeddings, in some embodiments. In some embodiments, the topic context module 208 may begin with a standard chunk of utterances and compute various lexical and/or discourse features from it. For example, semantic co-occurrences, speaker turns, silences, interruptions, or any other features may be computed. The topic context module 208 may detect drifts based on the pattern and/or distribution of one or more of any of these features. In some embodiments, once a drift has been determined, a boundary where the drift occurs is created in order to separate one topic context unit 404 from another, thereby separating one topic from another. In some embodiments, the topic context module 208 uses the lexical features to draw the boundary between different topic context units 404.

In some instances, meetings often begin with small talk or pleasantries that are irrelevant or less relevant to the core topics of the discussions. In some embodiments, the topic context module 208 uses a ML classifier, such as an RNN-based classifier, to classify the dialogue topics into different types. In some embodiments, once the types of topics are determined, the classification may be used to filter out a subset of data pertaining to less relevant or irrelevant topics such that resources are not wasted on summarizing irrelevant topics.

Moreover, the type of meeting may have an effect on the length of the topics discussed. For example, status meetings may have short-form topics while large project meetings may have long-form topics. In some embodiments, a time component of the topic context units 404 may be identified by the topic context module 208 to differentiate between long-form topics and short-form topics. While in some embodiments, a fix time duration may be implemented, in other embodiments, a dynamic timing algorithm may be implemented to account for differences between long-form topics and short-form topics.

Furthermore, as meeting topics change over the course of a meeting, not every participant may contribute to all the topics. For example, various members of a team may take turns providing status updates on their individual component of a project while a team lead weighs in on every component of the project. In some embodiments, the topic context module 208 identifies topic cues from the various topic context units and determines whether a speaker is critical to a particular topic of discussion. By determining a speaker's importance to a topic, extraneous discussions from non-critical speakers may be eliminated from the summary portion.

In some embodiments, the topic context module 208 may take the transcript text data from the ASR module 204 and conduct a sentiment analysis or intent analysis to determine speaker emotions and how certain speaker's reacted to a particular topic of conversation. In some embodiments, the topic context module 208 may take video data and conduct analyses on facial expressions to detect and determine speaker sentiments and emotions. The speaker emotions may subsequently be used to more accurately summarize the topics in relation to a speaker's sentiments toward that topic. In some embodiments, the topic context module 208 may detect user engagement from any or all participants and use increased user engagement as a metric for weighing certain topics or topic context units 404 as more important or a priority for subsequent summarization. For example, the more engaged a user is in discussing a particular topic, the more important that particular topic or topic context unit 404 will be for summarization. In some embodiments, increased user engagement levels maybe identified through audio and/or speech analysis (e.g. the more a participant speaks, more vehemently a participant speaks, etc.), video analysis (e.g. the more a participant appears engaged based on facial evaluation of video data to identify concentration levels or strong emotions), or any other types of engagement, such through increased use of emojis, hand raises, or any other functions. In some embodiments, the topic context module 208 may detect and categorize discourse markers to be used as input data for ML summarization. Discourse markers may include, for example, overlapping speech and/or different forms of interruptions, such as relationally neutral interruptions, power interruptions, report interruptions, or any other types of interruptions. In some embodiments, an interruption may indicate a drift that delineates one topic from another.

Once the topic context units 404 are generated by the topic context module 208 and/or the text annotated with speaker identities, timestamps, and other data by the speaker-aware context module 206, the summarization module 210 may create an abstractive summary 332, 406 of each topic represented by a topic context unit 404, in some embodiments.

### 3.6 Summarization Module

In an embodiment, a summarization module 210 is a DNN, such as the example neural network described in FIG. 3 that is trained to generate an abstractive summary 332, 406. In some embodiments, the summarization module 210 is trained to take a variety of data as input data, such as who spoke, when the speaker(s) spoke, what the speaker(s) discussed, the manner in which the speaker spoke and/or the emotions expressed, or any other types of data. For example, in reference to FIG. 3, the summarization module 210 may use speaker data 302 (e.g. a speaker's name, gender, etc.), context data 304 (e.g. timestamps corresponding to the speech, emotions while speaking, etc.), and content data 306 (e.g. content of the speech) obtained in relation to the topic context units 404 in order to generate a summary 332, 406. In some embodiments, additional discourse markers may also be used as input data. Discourse markers may include, for example, overlapping speech and/or different forms of interruptions, such as relationally neutral interruptions, power interruptions, report interruptions, or any other types of interruptions.

In some embodiments, the output generated by the summarization module 210 is a summary 332, 406 of the one or more topic context units 404. In some embodiments, the summary 332, 406 is an abstractive summary that the summarization module 210 creates independently using chosen words rather than an extractive summary that merely highlights existing words in a transcript. In some embodiments, the summary 332, 406 is a single sentence while in other embodiments, the generated summary 332, 406 is multiple sentences. In some embodiments where the speaker-aware context module 206 is used to tag speaker information and timestamps, the summarization module 210 may generate summaries that include which speakers discussed a particular topic. In some embodiments, the summarization module 210 may also generate speaker-specific summaries or allow for filtering of summaries by speaker. For example, the summarization module 210 may generate summaries of all topics discussed by one speaker automatically or in response to user selection. Moreover, generating speaker-specific summaries of various topics enables summarization from that particular individual's perspective rather than a generalized summary that fails to take into account differing viewpoints.

In some embodiments, once the summary 332, 406 is generated, the post-processing module 212 processes the summary 406 by including certain types of data to be displayed with the summary 332, 406, as further described herein.

### 3.7 Post-Processing Module

In some embodiments, a post-processing module 212 takes the summary 332, 406 generated by the summarization module 210 and adds metadata to generate a processed summary. In some embodiments, the processed summary includes the addition of timestamps corresponding to each of the topic context units 404 for which a summary 332, 406 is generated. In some embodiments, the processed summary includes speaker information, such as speaker identities, gender, or any other speaker-related information. This enables the subsequent display of the processed summary with timestamps or a time range during which the topic was discussed and/or speaker information. In some embodiments, the speaker-aware context module 206 passes relevant metadata to the post-processing module 212 for adding to the summary 332, 406. In some embodiments, additional speaker information that was not previously added by the speaker-aware context module 206 is passed from the speaker-aware context module 206 to the post-processing module 212 for adding to the summary 332, 406. In some embodiments, the post-processing step is excluded. For example, in some embodiments, the summarization module may generate a summary already complete with speakers and timestamps without the need for additional post-processing.

In some embodiments, the summary 332, 406 or processed summary is sent to the display module 214 for streaming live to one or more client devices 112B, 112B. In other embodiments, the summaries are stored in database 136 and then sent to one or more client devices 112B, 112B for subsequent display.

### 3.8 Display Module

In some embodiments, the display module 214 displays or causes a client device to stream an abstractive summary, such as summary 332, 406 or a processed summary produced by the post-processing module 212 to a display. In some embodiments, the display module 214 causes the abstractive summary to be displayed through a browser application, such as through a WebRTC session. For example, if client devices 112A, 112B were engaged in a WebRTC-based video conferencing session through a client application 114A, 114B such as a browser, then the display module 214 may cause a summary 332, 406 to be displayed to a user 110A, 110B through the browser.

In some embodiments, the display module 214 periodically streams summaries to the participants every time a summary 332, 406 or processed summary is generated from the topic context unit 404. In other embodiments, the display module 214 periodically streams summaries to the participants based on a time interval. For example, any summaries that have been generated may be stored temporarily and streamed in bulk to the conference session participants every 30 seconds, every minute, every two minutes, every five minutes, or any other time interval. In some embodiments, the summaries are streamed to the participants upon receiving a request sent from one or more client devices 112A, 112B. In some embodiments, some or all streamed summaries are saved in an associated database 136 for replaying or summarizing any particular conference session. In some embodiments, the summaries are adapted to stream in a VR or AR environment. For example, the summaries may be streamed as floating words in association with 3D avatars in a virtual environment.

### 4.0 Procedural Overview

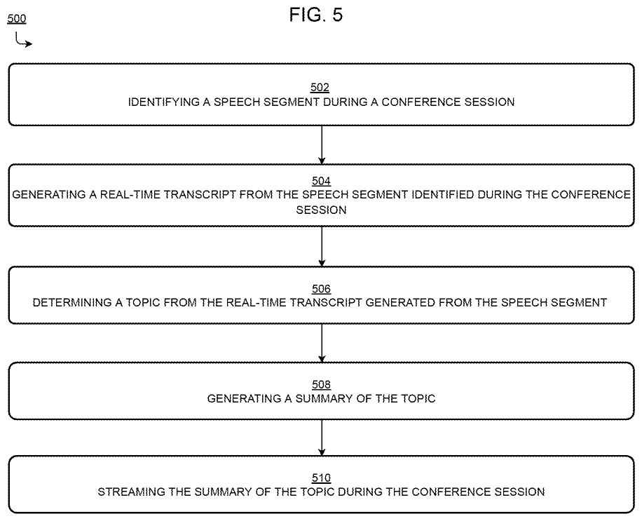

FIG. 5 is a flowchart depicting summary process 500, in an example embodiment. In some embodiments, one or more ML algorithms are trained to perform one or more of each step in the process 500. In some embodiments, the server 132 of FIG. 1 is configured to implement each of the following steps in the summary process 500. In other embodiments, a client device 112A, 112B may be configured to implement the steps.

At step 502, a speech segment is identified during a conference session. In some embodiments, the speech segment is identified from audio and/or video data. In some embodiments, a non-speech segment is removed. In some embodiments, non-speech segments may include background noise, silence, non-human sounds, or any other audio and/or video segments that do not include speech. Eliminating non-speech segments enables only segments featuring speech to be processed for summarization. In some embodiments, step 502 is performed by the voice activity module 202, as described herein in relation to FIG. 2 and FIG. 4. As an example, during a conference session between user 110A and user 110B, the voice activity module 202 identifies that user 110A, by the name of John, spoke starting from the beginning of the meeting (0:00) to the two minute and forty-five second (2:45) timestamp. The voice activity module 202 also identifies that a period of silence occurred between the two minute and forty-five second (2:45) timestamp to the three-minute (3:00) timestamp. Moreover, the voice activity module 202 identifies that user 110B, by the name of Jane, spoke from the three-minute (3:00) timestamp to the ten minute and 30 second (10:30) timestamp, followed by John's spoken words from the ten minute and 30 second (10:30) timestamp to the end of the meeting at the 12 minutes and 30 second (12:30) timestamp. In this example, John's spoken words from 0:00 to 2:45 and 10:30 to 12:30, as well as Jane's spoken words from 3:00 to 10:30 are each identified as speech segments while the period of silence between 2:45 and 3:00 is removed as a non-speech segment.

At step 504, a transcript is generated from the speech segment that was identified during the conference session. In some embodiments, the transcript is generated in real-time to transcribe an on-going conferencing session. In some embodiments, standard ASR methods may be used to transcribe the one or more speech segments. In other embodiments, ALR or AV-ASR methods may be used. Continuing the example from above, John's spoken words from 0:00 to 2:45 and 10:30 to 12:30, as well as Jane's spoken words from 3:00 to 10:30 are transcribed in real-time during the conference session using existing ASR, ALR, or AV-ASR methods. In some embodiments, the transcripts are tagged with additional data, such as speaker identity, gender, timestamps, or any other data. In the example above, John's name, Jane's name, and timestamps are added to the transcript to identify who said what and when.

At step 506, a topic is determined from the transcript that is generated from the speech segment. In some embodiments, a topic of discussion is represented by a topic context unit or paragraph. In some embodiments, one topic is delineated from another topic by evaluating a drift, or topic shift, from one topic to another. In an embodiment, this may be done by evaluating the similarity or differences between certain words. Continuing the example from above, if there is a drift from Jane's speech to John's speech at the 10:30 timestamp, then Jane's speech from 3:00 to 10:30 may be determined as one topic while John's speech from 10:30 to 12:30 may be determined as another topic. Conversely, if there is little to no drift from Jane's speech to John's speech at the 10:30 timestamp, then both their speech segments may be determined as belonging to a single topic.

In some embodiments, irrelevant or less relevant topics are excluded. For example, if John's topic from 0:00 to 2:45 covered opening remarks and pleasantries while Jane's topic from 3:00 to 10:30 and John's topic from 10:30 to 12:30 were related to the core of the discussion, then John's opening remarks and pleasantries may be removed as irrelevant or less relevant so that resources are not wasted on summarizing less relevant speech. In some embodiments, selected speakers may be determined as core speakers to particular topics, and therefore focused on for summarization. For example, it may be determined that Jane's topic from 3:00 to 10:30 is critical to the discussion, thereby making Jane's topic(s) a priority for summarization. In some embodiments, sentiments and/or discourse markers may be used to accurately capture the emotions or sentiments of the dialogue. For example, if John interrupts Jane at 10:30, then the type of interruption (e.g. neutral interruptions, power interruptions, report interruptions, etc.) may be determined to accurately summarize the discussion. In some embodiments, the type of interruption indicates a drift that delineates one topic from another. For example, if John neutrally interrupts Jane at 10:30, then John may be agreeing with Jane's perspective and no drift has occurred. However, if John power interrupts Jane at 10:30 with a final decision and moves on to concluding thoughts, then a drift has occurred and topics have shifted.

At step 508, a summary of the topic is generated. In some embodiments, the summary is an abstractive summary created from words that are chosen specifically by the trained ML model rather than words highlighted from a transcript. In the example above, Jane's topic from 3:00 to 10:30 is summarized in one to two sentences while John's topic from 10:30 to 12:30 is summarized in one to two sentences. In some instances where Jane and John discussed the same topic, the one to two sentence summary may cover what both Jane and John spoke about. In some embodiments, the summary may include the names of participants who spoke about a topic. For example, the summary may be: “Jane and John discussed the go-to-market strategy and concluded that the project was on track.” In some embodiments, the summary may also include timestamps of when the topic was discussed. For example, the summary be: “Jane and John discussed the go-to-market strategy from 3:00 to 12:30 and concluded that the project was on track.” In some embodiments, summary is generated with speaker and timestamp information already included while in other embodiments, the summary goes through post-processing in order to add speaker information and/or timestamps. In some embodiments, the summaries can be filtered by speaker. For example, upon user selection of a filter for Jane's topics, summaries of John's topics may be excluded while summaries of Jane's topics may be included for subsequent streaming or display.

At step 510, the summary of the topic is streamed during the conference session. In some embodiments, the streaming happens in real time during a live conference session. In some embodiments, a summary is streamed once a topic is determined and a summary is generated from the topic, creating a rolling, topic-by-topic, live streaming summary. For example, if Jane's topic is determined to be a separate topic from John's, then the summary of Jane's topic is immediately streamed to one or more participants of the conference session once the summary is generated, followed immediately by the summary of John's topic. In other embodiments, summaries of topics are saved and streamed after a time interval. For example, Jane's summary and John's summary may be stored for a time interval, such as one minute, and distributed in successive order after the one-minute time interval. In some embodiments, the summaries are saved in a database for later streaming, such as during a replay of a recorded meeting between Jane and John. In some embodiments, the summaries may be saved in a database and provided independently as a succinct, stand-alone abstractive summary of the meeting.

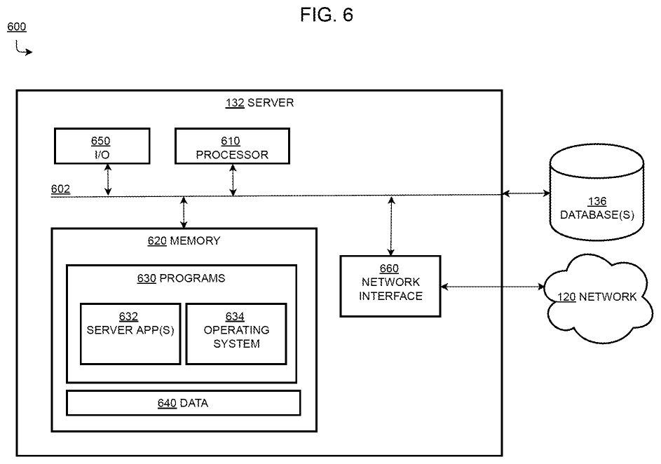

FIG. 6 shows a diagram 600 of an example conference server 132, consistent with the disclosed embodiments. The server 132 may include a bus 602 (or other communication mechanism) which interconnects subsystems and components for transferring information within the server 132. As shown, the server 132 may include one or more processors 610, input/output (“I/O”) devices 650, network interface 660 (e.g., a modem, Ethernet card, or any other interface configured to exchange data with a network), and one or more memories 620 storing programs 630 including, for example, server app(s) 632, operating system 634, and data 640, and can communicate with an external database 136 (which, for some embodiments, may be included within the server 132). The server 132 may be a single server or may be configured as a distributed computer system including multiple servers, server farms, clouds, or computers that interoperate to perform one or more of the processes and functionalities associated with the disclosed embodiments.

The processor 610 may be one or more processing devices configured to perform functions of the disclosed methods, such as a microprocessor manufactured by Intel™ or manufactured by AMD™. The processor 610 may comprise a single core or multiple core processors executing parallel processes simultaneously. For example, the processor 610 may be a single core processor configured with virtual processing technologies. In certain embodiments, the processor 610 may use logical processors to simultaneously execute and control multiple processes. The processor 610 may implement virtual machine technologies, or other technologies to provide the ability to execute, control, run, manipulate, store, etc. multiple software processes, applications, programs, etc. In some embodiments, the processor 610 may include a multiple-core processor arrangement (e.g., dual, quad core, etc.) configured to provide parallel processing functionalities to allow the server 132 to execute multiple processes simultaneously. It is appreciated that other types of processor arrangements could be implemented that provide for the capabilities disclosed herein.

The memory 620 may be a volatile or non-volatile, magnetic, semiconductor, tape, optical, removable, non-removable, or other type of storage device or tangible or non-transitory computer-readable medium that stores one or more program(s) 630 such as server apps 632 and operating system 634, and data 640. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The server 132 may include one or more storage devices configured to store information used by processor 610 (or other components) to perform certain functions related to the disclosed embodiments. For example, the server 132 includes memory 620 that includes instructions to enable the processor 610 to execute one or more applications, such as server apps 632, operating system 634, and any other type of application or software known to be available on computer systems. Alternatively or additionally, the instructions, application programs, etc. are stored in an external database 136 (which can also be internal to the server 132) or external storage communicatively coupled with the server 132 (not shown), such as one or more database or memory accessible over the network 120.

The database 136 or other external storage may be a volatile or non-volatile, magnetic, semiconductor, tape, optical, removable, non-removable, or other type of storage device or tangible or non-transitory computer-readable medium. The memory 620 and database 136 may include one or more memory devices that store data and instructions used to perform one or more features of the disclosed embodiments. The memory 620 and database 136 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, the server 132 may be communicatively connected to one or more remote memory devices (e.g., remote databases (not shown)) through network 120 or a different network. The remote memory devices can be configured to store information that the server 132 can access and/or manage. By way of example, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The programs 630 may include one or more software modules causing processor 610 to perform one or more functions of the disclosed embodiments. Moreover, the processor 610 may execute one or more programs located remotely from one or more components of the communications system 100. For example, the server 132 may access one or more remote programs that, when executed, perform functions related to disclosed embodiments.

In the presently described embodiment, server app(s) 632 causes the processor 610 to perform one or more functions of the disclosed methods. For example, the server app(s) 632 may cause the processor 610 to analyze different types of audio communications to separate multiple speakers from the audio data and send the separated speakers to one or more users in the form of transcripts, closed-captioning, speaker identifiers, or any other type of speaker information. In some embodiments, other components of the communications system 100 may be configured to perform one or more functions of the disclosed methods. For example, client devices 112A, 112B may be configured to separate multiple speakers from the audio data and send the separated speakers to one or more users in the form of transcripts, closed-captioning, speaker identifiers, or any other type of speaker information.

In some embodiments, the program(s) 630 may include the operating system 634 performing operating system functions when executed by one or more processors such as the processor 610. By way of example, the operating system 634 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, disclosed embodiments may operate and function with computer systems running any type of operating system 634. The server 132 may also include software that, when executed by a processor, provides communications with network 120 through the network interface 660 and/or a direct connection to one or more client devices 112A, 112B.

In some embodiments, the data 640 includes, for example, audio data, which may include silence, sounds, non-speech sounds, speech sounds, or any other type of audio data.

The server 132 may also include one or more I/O devices 650 having one or more interfaces for receiving signals or input from devices and providing signals or output to one or more devices that allow data to be received and/or transmitted by the server 132. For example, the server 132 may include interface components for interfacing with one or more input devices, such as one or more keyboards, mouse devices, and the like, that enable the server 132 to receive input from an operator or administrator (not shown).

What is claimed is:

1. A computer-implemented machine learning method for generating real-time summaries, the method comprising:
identifying a speech segment during a conference session;
generating a real-time transcript from the speech segment identified during the conference session;
determining a topic from the real-time transcript generated from the speech segment;
generating a summary of the topic; and
streaming the summary of the topic during the conference session.

2. The computer-implemented machine learning method of claim 1, wherein determining the topic from the real-time transcription comprises detecting a drift from the topic to another topic and determining the topic based on the drift.

3. The computer-implemented machine learning method of claim 2, wherein detecting the drift comprises detecting based on a pattern of lexical features.

4. The computer-implemented machine learning method of claim 1, wherein generating the real-time transcript comprises tagging a speaker identity or a timestamp, and wherein generating the summary of the topic comprises generating the summary using the speaker identity or the timestamp.

5. The computer-implemented machine learning method of claim 1, further comprising:
determining another topic from the real-time transcript generated from the speech segment;
determining an irrelevancy of the other topic; and
filtering out the other topic based on the irrelevancy.

6. The computer-implemented machine learning method of claim 1, wherein generating the summary of the topic comprises generating an abstractive summary, and wherein streaming the summary of the topic comprises streaming the abstractive summary.

7. The computer-implemented machine learning method of claim 1, further comprising:
processing the summary in response to generating the summary, wherein processing comprises adding a speaker identity or a timestamp; and
wherein streaming the summary comprises streaming the summary in response to the processing.

8. A non-transitory, computer-readable medium storing a set of instructions that, when executed by a processor, cause:
identifying a speech segment during a conference session;
generating a real-time transcript from the speech segment identified during the conference session;
determining a topic from the real-time transcript generated from the speech segment;
generating a summary of the topic; and
streaming the summary of the topic during the conference session.

9. The non-transitory, computer-readable medium of claim 8, wherein determining the topic from the real-time transcription comprises detecting a drift from the topic to another topic, and wherein determining the topic comprises determining based on the drift.

10. The non-transitory, computer-readable medium of claim 9, wherein detecting the drift comprises detecting based on a pattern of lexical features.

11. The non-transitory, computer-readable medium of claim 8, wherein generating the real-time transcript comprises tagging a speaker identity or a timestamp, and wherein generating the summary of the topic comprises generating the summary using the speaker identity or the timestamp.

12. The non-transitory, computer-readable medium of claim 8, storing further instructions that, when executed by the processor, cause:
determining another topic from the real-time transcript generated from the speech segment;
determining an irrelevancy of the other topic; and
filtering out the other topic based on the irrelevancy.

13. The non-transitory, computer-readable medium of claim 8, wherein generating the summary of the topic comprises generating an abstractive summary, and wherein streaming the summary of the topic comprises streaming the abstractive summary.

14. The non-transitory, computer-readable medium of claim 8, storing further instructions that, when executed by the processor, cause:
processing the summary in response to generating the summary, wherein processing comprises adding a speaker identity or a timestamp; and
wherein streaming the summary comprises streaming the summary in response to the processing.

15. A machine learning system for generating real-time summaries, the system comprising:
a processor;
a memory operatively connected to the processor and storing instructions that, when executed by the processor, cause:
identifying a speech segment during a conference session;
generating a real-time transcript from the speech segment identified during the conference session;
determining a topic from the real-time transcript generated from the speech segment;
generating a summary of the topic; and
streaming the summary of the topic during the conference session.

16. The machine learning system of claim 15, wherein determining the topic from the real-time transcription comprises detecting a drift from the topic to another topic and determining the topic based on the drift.

17. The machine learning system of claim 16, wherein detecting the drift comprises detecting based on a pattern of lexical features.

18. The machine learning system of claim 15, wherein the memory stores further instructions that, when executed by the processor, cause:
determining another topic from the real-time transcript generated from the speech segment;
determining an irrelevancy of the other topic; and
filtering out the other topic based on the irrelevancy.

19. The machine learning system of claim 15, wherein generating the summary of the topic comprises generating an abstractive summary, and wherein streaming the summary of the topic comprises streaming the abstractive summary.

20. The machine learning system of claim 15, wherein the memory stores further instructions that, when executed by the processor, cause:
processing the summary in response to generating the summary, wherein processing comprises adding a speaker identity or a timestamp; and
wherein streaming the summary comprises streaming the summary in response to the processing.
